(19) United States
(12) Patent Application Publication
(10) Pub. No.: US 2005/0152580 A1
(43) Pub. Date: Jul. 14, 2005

(54) Obstacle detecting apparatus and method

(75) Inventors: Kenji Furukawa, Tokyo (JP); Ryuzo Okada, Tokyo (JP); Kazunori Onoguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/007,209

(22) Filed: Dec. 9, 2004

(30) Foreign Application Priority Data
Dec. 16, 2003 (JP) 2003-418201

(51) Int. Cl. G06K 9/00

(52) U.S. Cl. 382/103; 340/435; 348/148

(57) ABSTRACT

An apparatus that detects an obstacle using images shot by an image shooting device mounted on a mobile object on a plane, the apparatus comprising: an image receiving unit configured to receive time-series images shot by the image shooting device; an area setting unit configured to set a plurality of processing areas in the images received by the image receiving unit; an object motion detector configured to detect objects moving within the areas set by the area setting unit and to detect motion trajectories of the objects; an obstacle candidate detector configured to detect the respective objects as obstacle candidates if a direction of a line connecting between the objects is a predetermined direction; and an obstacle determining unit configured to compare the motion trajectories of the respective obstacle candidates and to determine the obstacle candidates as an obstacle if the motion trajectories of the obstacle candidates satisfy a predetermined similarity condition.

### CROSS-REFERENCE TO RELATED APPLICATIONS

This application is based upon and claims the benefit of priority from the prior Japanese Patent Application No. 2003-418201 filed on Dec. 16, 2003; the entire contents of which are incorporated herein by reference.

### BACKGROUND OF THE INVENTION

1) Field of the Invention

The present invention relates to a technology for detecting an obstacle around a moving object such as an automobile.

2) Description of the Related Art

Conventionally, as a technique for detecting an obstacle around a moving object such as an automobile, a method using one video camera is proposed. According to the technique using one video camera, as compared to another technique using a plurality of video cameras, there are advantages that a detecting device is easier to be installed in the automobile or the like and the device cost can be reduced.

As the technique using one video camera, a method for detecting an automobile in front (obstacle) is proposed. In the method, the automobile in front is detected by deciding a horizontal edge line in an image, which is shot by a camera installed in the automobile of interest or the like, as a ground contact line of the automobile in front (for example, see Japanese Patent Application Laid-Open (JP-A) Nos. H07-280517 and H07-28975).

Further, a technique for detecting only obstacles having a certain height from the road plane is proposed. In the method, the obstacles are detected by detecting optical flows from time-series images of the front side of the automobile shot by the video camera of the automobile, and estimating the height of each flow from the road plane using a car speed sensor. (for example, see JP-A No. 2000-123183).

However, by the above described technique for detecting the edge line in the image (see JP-A Nos. H07-280517 and H07-28975), even when the edge line in the image is actually not the ground contact line of the vehicle, for example, when the paint on the road plane, the joint of asphalt, or the like is detected as the edge line, the edge line may be nevertheless decided as a contact line of the vehicle, and false obstacle detection may be performed.

Further, in the method for detecting optical flows in the image (see JP-A No. 2000-123183), since it is assumed in the conventional method that all of the flows within the road plane remain stationary, there may be a problem that the shadow of an automobile traveling outside the monitored area within the image, the shadow of the own automobile in the evening, or the like may be falsely detected as an obstacle.

### SUMMARY OF THE INVENTION

It is an object of the present invention to at least solve the problems in the conventional technology.

An apparatus according to one aspect of the present invention that detects an obstacle using images shot by an image shooting device mounted on an mobile object on a plane, the apparatus includes an image receiving unit configured to receive time-series images shot by the image shooting device; an area setting unit configured to set a plurality of processing areas in the images received by the image receiving unit; an object motion detector configured to detect objects moving within the areas set by the area setting unit and to detect motion trajectories of the objects; an obstacle candidate detector configured to detect the respective objects as obstacle candidates if a direction of a line connecting between objects is a predetermined direction; and an obstacle determining unit configured to compare the motion trajectories of the respective obstacle candidates and to determine the obstacle candidates as an obstacle if the motion trajectories of the obstacle candidates satisfy a predetermined similarity condition.

A method according to another aspect of the present invention of detecting an obstacle using images shot by an image shooting device mounted on an mobile object on a plane, the method includes receiving time-series images shot by the image shooting device; setting a plurality of processing areas in the images received; detecting objects moving within the plurality of processing areas; detecting motion trajectories of the objects; detecting the respective objects as obstacle candidates if a direction of a line connecting between objects is a predetermined direction; comparing the motion trajectories of the respective obstacle candidates; and determining the obstacle candidates as an obstacle if the motion trajectories of the obstacle candidates satisfy a predetermined similarity condition.

### BRIEF DESCRIPTION OF THE DRAWINGS

FIG. 1 is a block diagram that depicts the functional constitution of an obstacle detecting apparatus according to one embodiment of the present invention;

FIG. 2 is a diagram that explains a mounting position of an image shooting device to an automobile in which the obstacle detecting apparatus is installed;

FIG. 3 is a diagram that explains a shooting area by the image shooting device;

FIG. 4 is an example of an image shot by the image shooting device and input to the obstacle detecting apparatus;

FIG. 5 is a diagram that explains detected information by a lower part motion trajectory detecting unit which is an element of the obstacle detecting apparatus;

FIG. 6 is a diagram that explains detected information by an upper part motion trajectory detecting unit which is an element of the obstacle detecting apparatus;

FIG. 7 is a diagram that explains an obstacle candidate search area set by an obstacle candidate search area setting unit which is an element of the obstacle detecting apparatus;

FIG. 8 is a diagram that explains criteria by an obstacle determining unit which is an element of the obstacle detecting apparatus;

FIG. 9 is a flowchart that depicts the procedure of obstacle detection processing by the obstacle detecting apparatus;

FIG. 10 is a diagram that explains false detection of the shadow of an automobile as an obstacle in a conventional obstacle detecting apparatus;

FIG. 11 is a diagram that explains a reason for that the false detection can be suppressed by the obstacle detecting apparatus according to the embodiment; and

FIG. 12 is another diagram that explains a reason for that the false detection can be suppressed by the obstacle detecting apparatus according to the embodiment.

### DETAILED DESCRIPTION

Exemplary embodiments relating to the present invention will be explained in detail below with reference to the accompanying drawings.

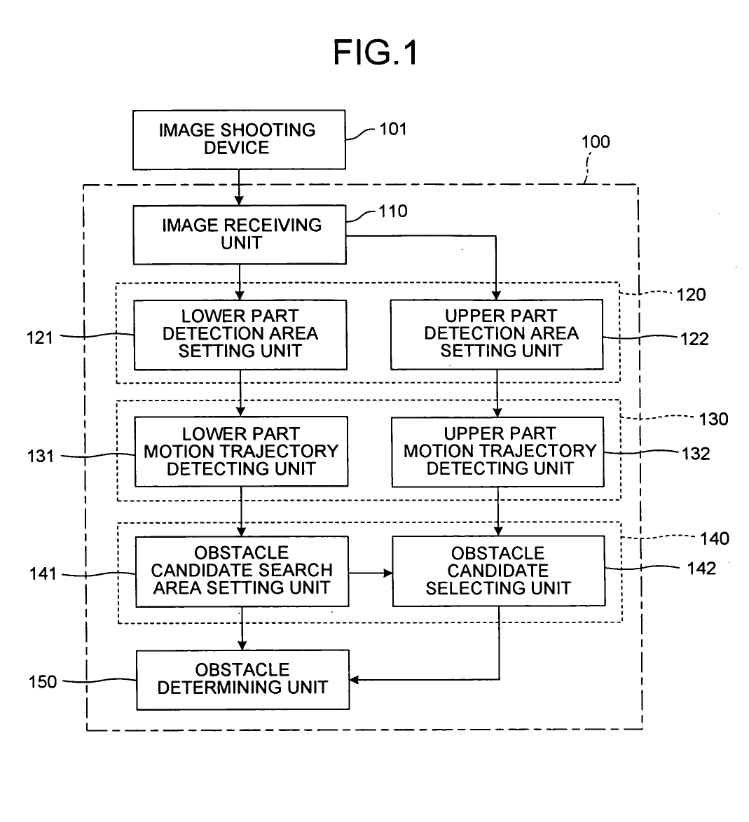

FIG. 1 is a block diagram that depicts the constitution of an obstacle detecting apparatus according to one embodiment of the present invention. This obstacle detecting apparatus 100 includes an image receiving unit 110, a processing area setting unit 120, an object motion detecting unit 130, an obstacle candidate detecting unit 140, and an obstacle determining unit 150.

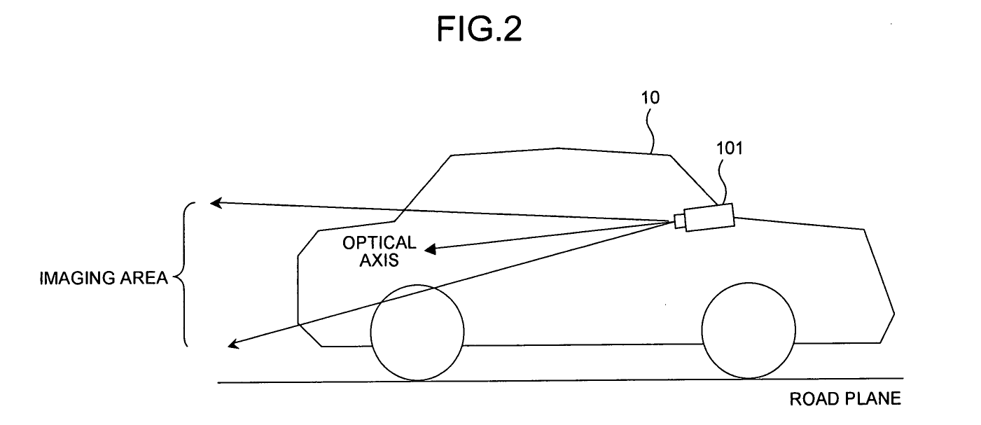

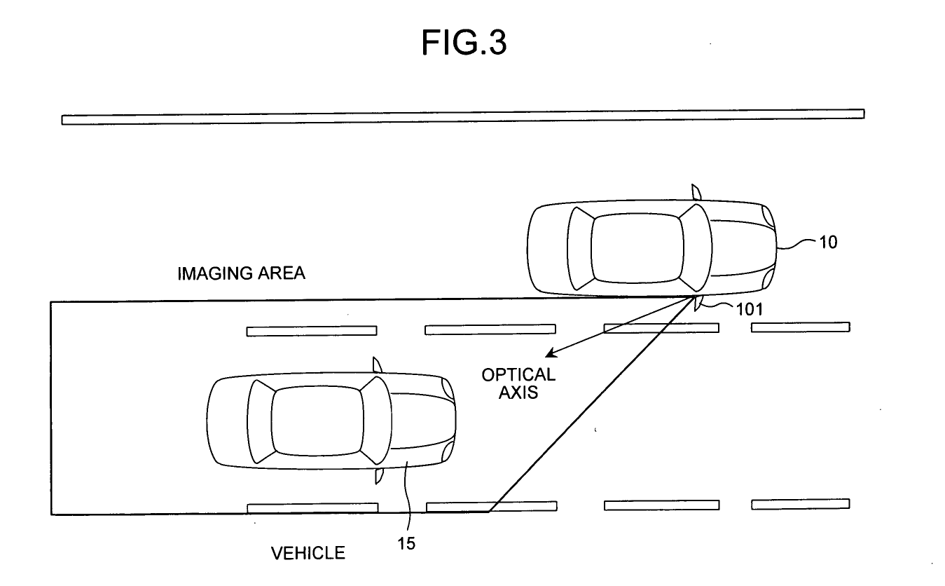

Time-series images (dynamic images containing continuous frame images) shot by one image shooting device 101 are received by the image receiving unit 110. In the embodiment, the image shooting device 101 is installed in an automobile. Here, referring to FIGS. 2 and 3, a position where the image shooting device 101 is installed in the embodiment is explained.

As shown in FIG. 2, the image shooting device 101 is mounted in a position near a side mirror (or within the side mirror) of an automobile 10. Further, the image shooting device 101 is oriented from the mounted position such that the field of view of the image shooting device 101 includes the rearward of an adjacent lane of the automobile 10. Furthermore, the image shooting device 101 is oriented slightly lower than the traveling direction of the automobile 10.

By thus mounting the image shooting device 101, as shown in FIG. 3, the image shooting device 101 can shoot the area rearward of the automobile 10 of interest in an adjacent lane to the lane in which the automobile 10 is traveling. Therefore, the device can include an automobile 15 traveling rearward of the automobile 10 of interest in the adjacent lane to the lane in which the automobile 10 is traveling in its shooting range.

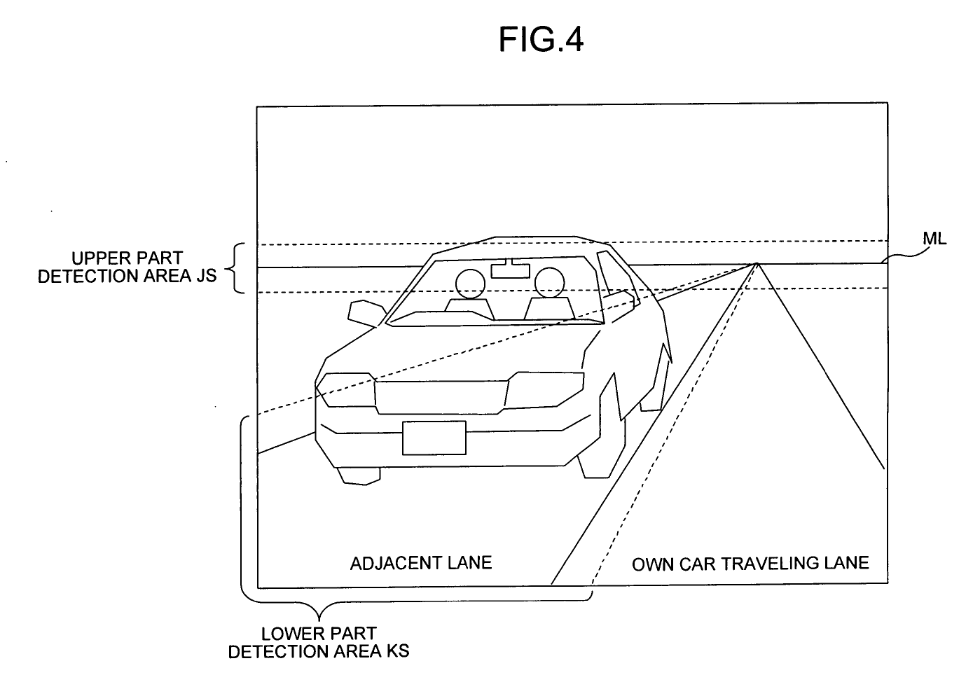

When the automobile 15 is traveling rearward of the automobile 10 in the adjacent lane as shown in FIG. 3, an image shown in FIG. 4 is shot by the image shooting device 101. As shown in FIG. 4, there are a road plane at the lower side of the shot image by the image shooting device 101, a lane in which the automobile 10 is traveling on the right side part thereof, and an adjacent lane on the left side part thereof. The automobile 15 traveling rearward of the automobile 10 appears on the adjacent lane.

The obstacle detecting apparatus 100 in the embodiment is an apparatus that detects a mobile object such as an automobile or a motorcycle traveling rearward in the adjacent lane as an obstacle. That is, since there is a danger of colliding or the like when the automobile 10 of interest changes lanes if an automobile, a motorcycle, or the like exists in the area rearward of the automobile 10 of interest in the adjacent lane, the obstacle detecting apparatus 100 detects the mobile object such as an automobile existing in such an area as an obstacle.

The image shooting device 101 output time-series images obtained by shooting the range as described above to the image receiving unit 110. The image receiving unit 110 receives these images and supply the images to a processing area setting unit 120. The processing area setting unit 120 sets plural processing areas in the images. In the embodiment, the processing area setting unit 120 includes a lower part detection area setting unit 121 that sets a lower part area in the image and an upper part detection area setting unit 122 that sets an upper part area in the image, and therefore two processing areas are set.

In the embodiment, the lower part detection area setting unit 121 sets an area in which an obstacle is to be detected in the shot image as a processing area. The obstacle as a target of detection in the embodiment is an automobile or the like traveling on the same plane (including nearly on the same plane), that is, on the same road plane as the automobile 10 mounting the obstacle detecting apparatus 100 of interest. As described above, the object to be detected as an obstacle is an automobile or the like traveling rearward of the own car on the road plane in the adjacent lane. Therefore, the lower part detection area setting unit 121 sets an area (the area surrounded by a broken line) including the part in which the adjacent lane on the road plane appears in the shot image as a lower part detection area KS as shown in FIG. 4.

On the other hand, the upper part detection area setting unit 122 sets a rectangular area JS of the shot image area shown in FIG. 4 as an upper part detection area. The rectangular area JS includes a vanishing line ML of the road plane as a plane on which the automobile 10 of interest and an automobile or the like as an obstacle are traveling. Here, the vanishing line ML of the road plane refers to a horizontal line that appears in the image as shown in FIG. 4.

An object motion detecting unit 130 focuses on images within the plural areas set by the processing area setting unit 120 as described above, and, if moving objects exist in the respective areas, detects trajectories of motion such as amounts and directions of movement of the objects. As described above, in the embodiment, since the two areas of the upper part detection area JS and the lower part detection area KS are set, the object motion detecting unit 130 has a lower part motion trajectory detecting unit 131 that performs motion trajectory detecting processing on images within the lower part detection area KS and an upper part motion trajectory detecting unit 132 that performs motion trajectory detecting processing on images within the upper part detection area JS.

The lower part motion trajectory detecting unit 131 extracts areas near the horizontal line segments in the images within the lower part detection area KS and tracks the extracted areas with respect to each image frame so as to detect motion trajectories such as degrees of movement in the horizontal line segment areas. Many horizontal line segments, such as ground contact lines of the road and the vehicle and bumpers, may exist in the vehicle traveling on the road plane. The ground contact line, which is a border line between the ground plane and the vehicle, is advantageously detected by the apparatus according to the embodiment. When the image shooting device 101 is mounted in the above described position, the horizontal line segments relating to the vehicle are detected as horizontal line segments in the image. Accordingly, assuming that such horizontal line segments are moving objects such as vehicles, motion trajectory detection of the moving objects such as vehicles is performed.

A method for detecting horizontal line segments using separability proposed in K. Fukui, “Edge Extraction Method based on Separability of Image Features (IEICE Trans. Inf. Syst, Vol. E-78-D, No. 12, 1995) (the entire contents of this reference are incorporated herein by reference)” can be used. Using such a method, horizontal line segments can be detected stably even for a vehicle in which no clear edge exists.

In the embodiment, considering that sometimes the horizontal line is corresponding to the ground contact line of the road plane and the vehicle, since the upper part of the horizontal line segment is the vehicle, not the horizontal line area itself, but its upper part area is tracked as a tracking area. Then, coordinates of the horizontal line on the image are output as motion trajectories with respect to each image frame. Many techniques of tracking detected partial areas are proposed, and a technique proposed in Okada and Onoguchi, “Monocular Image Processing System for Low-speed Distance Control (PRMU 2002-140, pp. 69-74, 2002) (the entire contents of this reference are incorporated herein by reference)” is used in the embodiment. Using such a method, detected horizontal line segments are tracked accurately, and their motion trajectories can be detected stably.

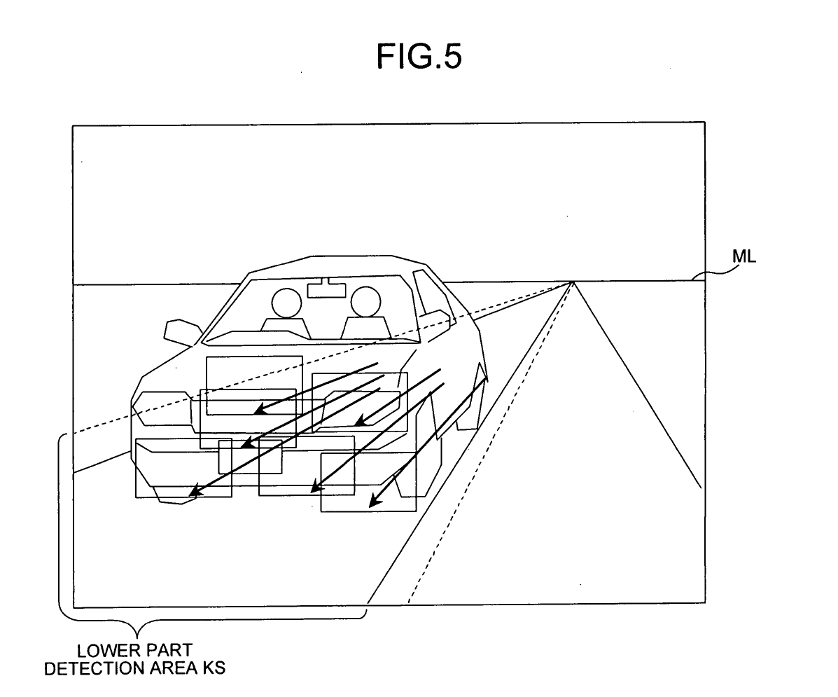

For example, when an overtaking vehicle in the adjacent lane approaches the vehicle of interest, as shown in FIG. 5, areas (shown by rectangular frames in the drawing) near the horizontal line segments of the various parts of the overtaking vehicle of interest are detected and their tracks (shown by arrows in the drawing) are detected by the lower part motion trajectory detecting unit 131.

The upper part motion trajectory detecting unit 132 extracts vertical line component areas in the images within the upper part detection area JS and tracks the extracted areas with respect to each image frame so as to detect motion trajectories such as degrees of movement in the vertical line segment areas. As described above, since the movement of the overtaking vehicle is large in the horizontal direction in the images within the upper part detection area JS including the vanishing line ML of the road plane, it is desired that vertical line segments are detected and tracked in order to track such a largely moving object in the horizontal direction correctly. Accordingly, in the embodiment, using the same technique as that in the lower part motion trajectory detecting unit 131, the detection of vertical line segments and tracking thereof are performed, and thereby, motion trajectories are detected. The extraction of moving objects such as vehicles and their tracking may be performed using a method other than the above described detecting method of motion trajectories.

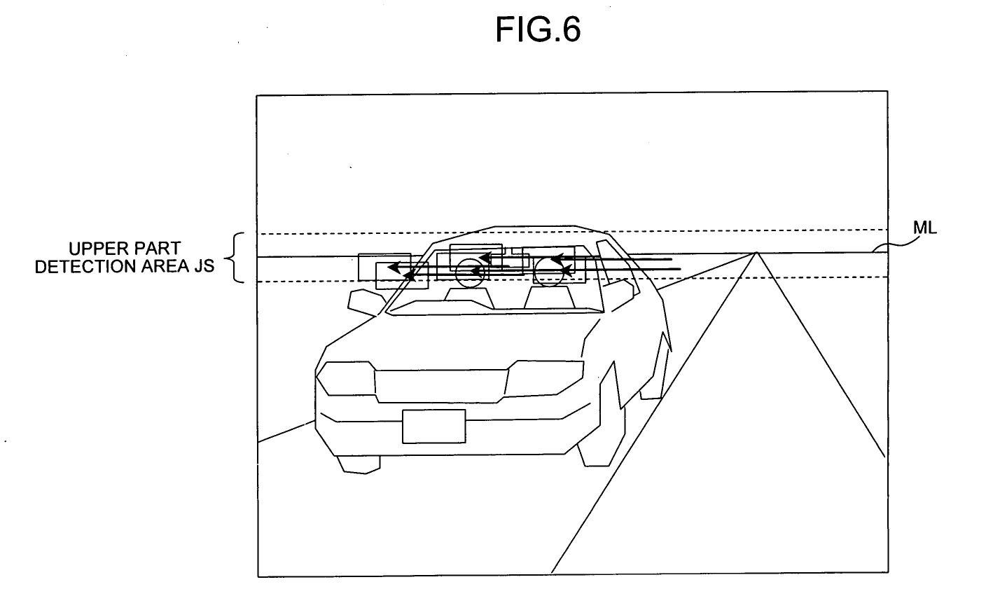

For example, when an overtaking vehicle in the adjacent lane approaches the vehicle of interest, as shown in FIG. 6, plural areas (shown by rectangular frames in the drawing) of the vertical line segments of the overtaking vehicle of interest are detected and their tracks (shown by arrows in the drawing) are detected by the upper part motion trajectory detecting unit 132.

An obstacle candidate detecting unit 140 detects obstacle candidates appearing in the areas based on the detection result of motion trajectories for the images within the lower part detection area KS supplied from the lower part motion trajectory detecting unit 131 and the detection result of motion trajectories for the images within upper part detection area JS from the upper part motion trajectory detecting unit 132.

The obstacle candidate detecting unit 140 in the embodiment detects objects appearing in the respective areas as obstacle candidates when the objects within the respective areas KS and JS are aligned along a vertical direction as a predetermined direction. That is, when objects appearing within the respective areas KS and JS are aligned along a vertical direction as a direction perpendicular to the vanishing line ML of the road plane, in other words, when the line connecting both objects is in a vertical direction as a predetermined direction (including the case where it is substantially in the vertical direction), these objects (estimated as the same object) are detected as obstacle candidates.

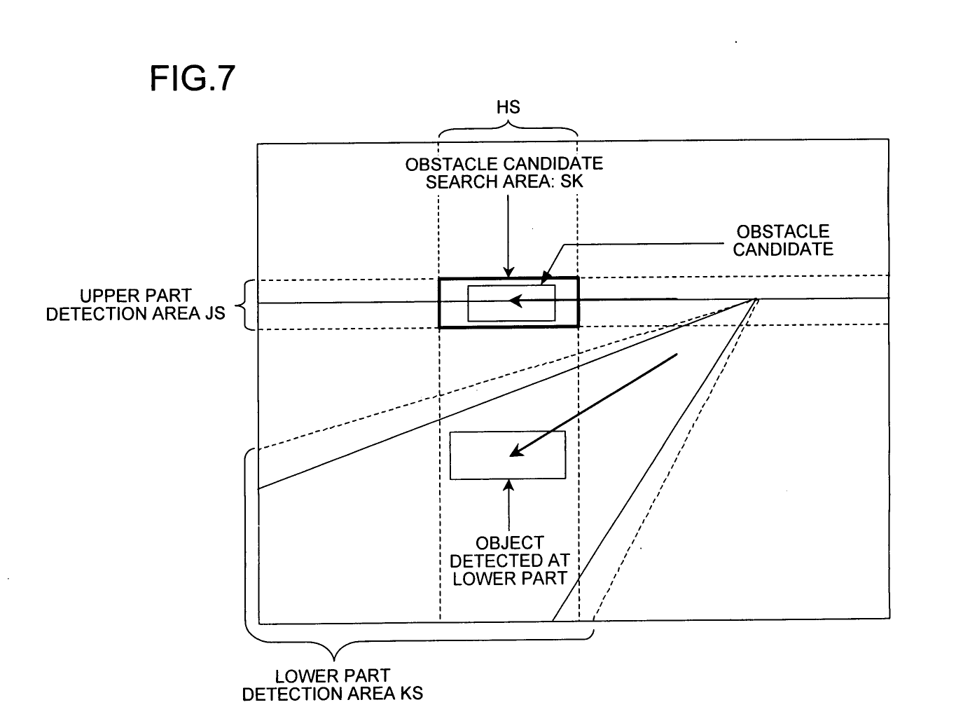

More specifically, the obstacle candidate detecting unit 140 has an obstacle candidate search area setting unit 141 and an obstacle candidate selecting unit 142. When the motion trajectory of the object approaching the own vehicle is detected in the image within the lower part detection area KS, the obstacle candidate search area setting unit 141 sets a range above the range including the vicinity of the detected object of interest in the upper part detection area JS as an obstacle candidate search area SK (the area shown by a heavy line in the drawing) as shown in FIG. 7.

That is, the range in which the upper part detection area JS and an area HS having a width including the detected range near the object cross each other is defined as the obstacle candidate search area SK. If a moving object exists in the image within the obstacle candidate search area SK, the moving object of interest in the image and the moving object detected within the lower part detection area KS exist aligned along the vertical direction. In other words, by searching whether an object exists in such an obstacle candidate search area SK, whether objects detected within the respective areas KS and JS exist aligned along the vertical direction can be detected.

The obstacle candidate selecting unit 142 determines whether a moving object exists in the image within the obstacle candidate search area SK set as described above, if it exists, the moving object the existence of which is confirmed within the obstacle candidate search area SK and the moving object detected within the lower part detection area KS are selected as obstacle candidates.

The obstacle determining unit 150 determines whether an obstacle exists based on the detection result of the lower part motion trajectory detecting unit 131, the detection result of the upper part motion trajectory detecting unit 132, and the selection result of the obstacle candidate selecting unit 142. Specifically, the obstacle determining unit 150 performs the determination as below.

First, if no object or motion trajectory thereof is detected by the lower part motion trajectory detecting unit 131, the obstacle determining unit 150 determines that no obstacle exists. As described above, since the obstacle detecting apparatus 100 in the embodiment is for detecting whether an overtaking vehicle or the like exists in an obstacle detection target area rearward of the own vehicle in the adjacent lane, if no moving object exists in the image within the lower part detection area KS including the detection target area, that means no moving object exists in the obstacle detection target area.

Then, the obstacle determining unit 150 determines that no obstacle exists even if an object and a motion trajectory thereof are detected by the lower part motion trajectory detecting unit 131, but no obstacle candidate is selected by the obstacle candidate selecting unit 142. That is, even if a moving object is detected within the lower detection area KS, but no moving object exists within the above obstacle candidate search area SK, the unit determines that the moving object within the lower detection area KS is not a vehicle or the like traveling in the detection target area rearward of the own car in the adjacent lane.

When an object and a motion trajectory thereof are detected by the lower part motion trajectory detecting unit 131 and obstacle candidates are selected by the obstacle candidate selecting unit 142, that is, when an object is detected in the obstacle candidate search area SK of the upper part detection area JS, the obstacle determining unit 150 compares the motion trajectories (such as directions and amounts of movement) of the objects detected in the respective areas and determines whether they satisfy a predetermined similarity condition. Then, if they satisfy the predetermined similarity condition, the unit determines that the moving objects (the same object) detected in the respective areas are an obstacle.

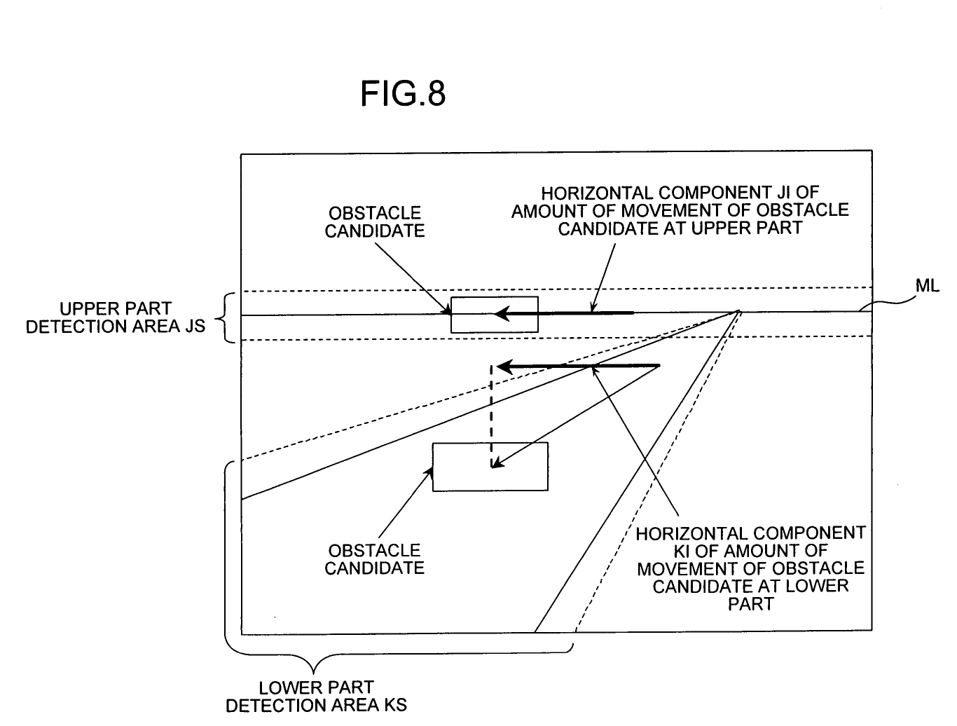

As shown in FIG. 8, in the embodiment, a similarity condition in which a horizontal component KI of the amount of movement of the object detected within the lower part detection area KS and a horizontal component JI of the amount of movement of the object detected within the upper part detection area JS satisfy the following relationship.
KI−JI≦±α

Here α is a constant representing an acceptable range of error. That means the unit determines that the objects detected in the respective areas are the same object if the horizontal components of the amounts of movement of both objects are identical or substantially identical, and, in this case, determines the object is an obstacle.

That is, the obstacle determining unit 150 in the embodiment determines that there is an obstacle (traveling on the road plane rearward of the own car in the adjacent lane) in the obstacle detection target area only if the following conditions are satisfied:
(1) a moving object is detected within the lower part detection area KS;
(2) a moving object is detected within the upper part detection area JS and within an area (that is, the obstacle candidate search area SK) aligned along the vertical direction with the object detected within the lower part detection area KS; and
(3) the horizontal components of the amounts of movement of the moving objects detected in these respective areas are substantially identical.

As above, the constitution of the obstacle detecting apparatus 100 in the embodiment has been described. Next, the processing operation for obstacle detection performed by the obstacle detecting apparatus 100 having the constitution is explained.

When the obstacle detecting apparatus 100 is in operation, time-series images shot by the image shooting device 101 are constantly sent to the apparatus of interest by the image receiving unit 110. Then, the lower part detection area KS and the upper part detection area JS set by the above described processing area setting unit 120 in the shot images are supplied to the object motion detecting unit 130, and the object motion detecting unit 130 detects whether a moving object exists in the images in the lower part detection area KS and the upper part detection area JS. Then, if a moving object is detected, its motion trajectory is detected and stored in a memory or the like.

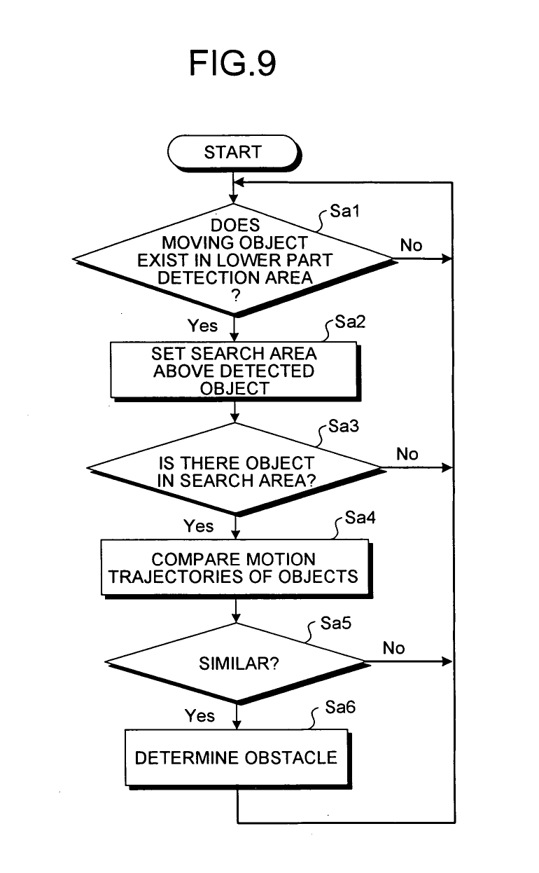

In the obstacle detecting apparatus 100, operation such as image receiving, area settings, motion trajectory detection as described above are constantly performed, and the obstacle candidate detecting unit 140 and the obstacle determining unit 150 performs processing for detecting an obstacle based on results of constantly performed motion trajectory detection processing or the like. The procedure of the processing is explained by referring to FIG. 9.

As shown in the same drawing, the obstacle candidate detecting unit 140 determines whether the existence of a moving object is detected in the images within the lower part detection area KS based on the detection result of the object motion detecting unit 130 (step Sa1). Then, if the moving object is detected within the lower part detection area KS, an area above the detected object of interest in the upper part detection area JS is set as the obstacle candidate search area SK (see FIG. 7) (step Sa2).

After the obstacle candidate search area SK is thus set, the obstacle candidate detecting unit 140 determines whether a moving object exists in the images within the obstacle candidate search area SK based on the detection result of the object motion detecting unit 130 (step Sa3).

If a moving object exists in the images within the obstacle candidate search area SK, the obstacle determining unit 150 compares the amount of movement of the object detected within the obstacle candidate search area SK and the amount of movement of the object detected at the step Sa1 (Step Sa4). In the embodiment, the amounts of movement of two object at the time of interest and the past given time are detected and stored in the memory by the object motion detecting unit 130 and compared.

Then, whether the amounts of movement of the objects in the images detected within the respective areas SK and KS satisfy a predetermined similarity condition is determined (step Sa5). Then, if the similarity condition is satisfied, the moving objects detected in the respective areas (the same object) are determined as an obstacle (step Sa6).

As described above, the predetermined similarity condition is to satisfy the relationship that the horizontal component KI of the amount of movement of the object detected within the lower part detection area KS and the horizontal component JI of the amount of movement of the object detected within the upper part detection area JS are substantially identical (see FIG. 8).

As described above, in the embodiment, the obstacle detection is performed by focusing on plural areas such as the lower part detection area KS and the upper part detection area JS of the images shot by the one image shooting device 101 and, when objects in the images within these areas are aligned along a predetermined direction (the vertical direction perpendicular to the vanishing line ML), comparing amounts of movement of the objects in the respective images, and determining these objects in the images as an obstacle if the amounts are similar.

The reason for determining an object as an obstacle if such a condition is satisfied is explained. As described above, in the obstacle detecting apparatus 100 in the embodiment, what is required to be detected as an obstacle is an automobile or the like traveling on the road rearward of the own car in the adjacent lane. Accordingly, it is not necessary to detect other automobiles or the like (for example, an automobile traveling rearward in the lane in which the own car is traveling or an automobile traveling in a lane next to the adjacent lane) as obstacles.

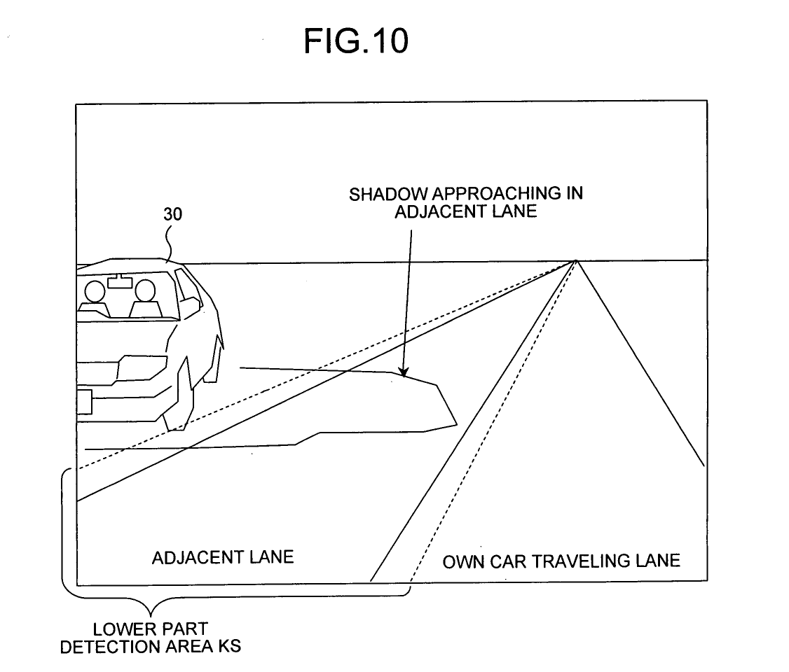

For example, as shown in FIG. 10, it is necessary not to detect an automobile 30 or the like traveling in a lane next to the adjacent lane to the lane in which the own car is traveling as an obstacle. However, when the shadow of the automobile 30 appears in the adjacent lane as the obstacle detection target area as shown in the drawing, by the simple method for detecting that an obstacle exists if a moving object exists in the area (corresponding to the lower part detection area KS) in which the adjacent lane as the obstacle detection target area appears, false detection such that the shadow of the automobile 30 is detected as an obstacle is occurred.

Since the above described false detection such that the shadow or the like is detected as an obstacle is occurred when a motion of an object or the like is detected by focusing only on the area in which the road in the detection target area appears, in the embodiment, not only the detection of object within the lower part detection area KS corresponding to the detection target area, but also the detection of object motion in the upper part detection area JS is performed.

That is, an automobile or the like traveling on the road in the shot image by the image shooting device 101 is an object extending in a height direction (for example, on the order of 1.5 m for a passenger car, equal to or more than 2 m for a truck). Accordingly, in the shot image, the upper portion (roof or the like) of the automobile traveling in the adjacent lane appears in a position protruding to an area other than the lower part detection area KS corresponding to the obstacle detection target area (see FIG. 5 or the like).

When an object (a normal automobile or the like) having a height higher than the height (see FIG. 2) at which the image shooting device 101 is installed (higher than the height from the road plane to the side mirror) is traveling on the road plane, in the shot image, the lower portion of the moving object such as an automobile or the like appears in an area in which the road plane appears (area corresponding to the lower part detection area KS), and the upper portion of the automobile or the like higher than the shooting device appears above the vanishing line ML in the image. Further, the upper portion and the lower portion in the image belong to the same object, the respective portions appear aligned in the vertical direction as a direction perpendicular to the vanishing line ML.

That is, when an object having a height such as an automobile travels in the adjacent lane, not only the object appears in the lower part detection area KS in which the road plane of the adjacent lane of interest appears, but also the object appears in the upper part detection area JS including the vanishing line ML. On the contrary, since the shadow on the adjacent lane as shown in FIG. 10 is not an object having a height (a height higher than the shooting position), it simply appears in the lower part detection area KS but does not appear in the upper part detection area JS.

Therefore, as in the embodiment, by performing detection of objects in two areas such as the lower part detection area KS and the upper part detection area JS, and detecting the objects as object candidates only if the detected objects are aligned along the vertical direction, the shadow as described above (see FIG. 10) is prevented from being falsely detected as an obstacle.

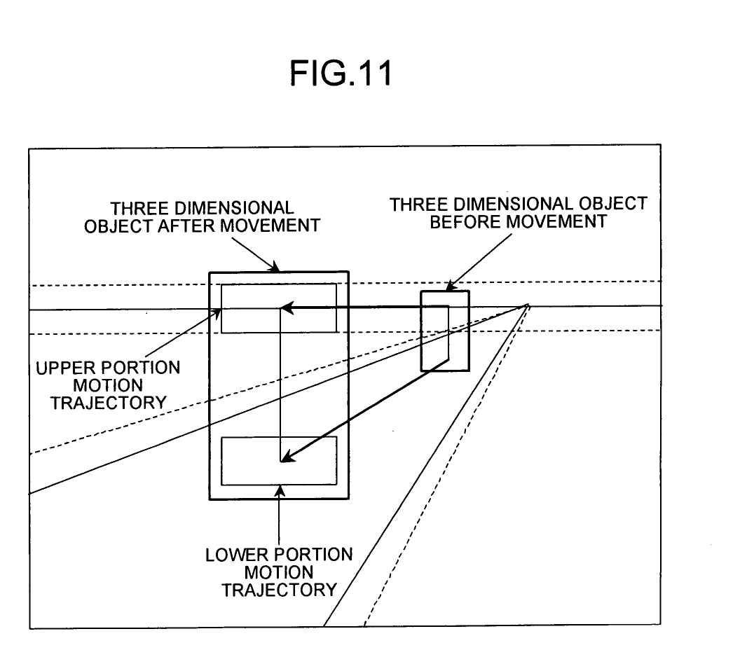

As shown in FIG. 11, when a three-dimensional object (shown in a rectangular shape in the drawing) having a height of some degree such as an automobile traveling in the adjacent lane as described above moves so as to approach the own car, the rectangular object in the image becomes larger and moves from right to left in the drawing.

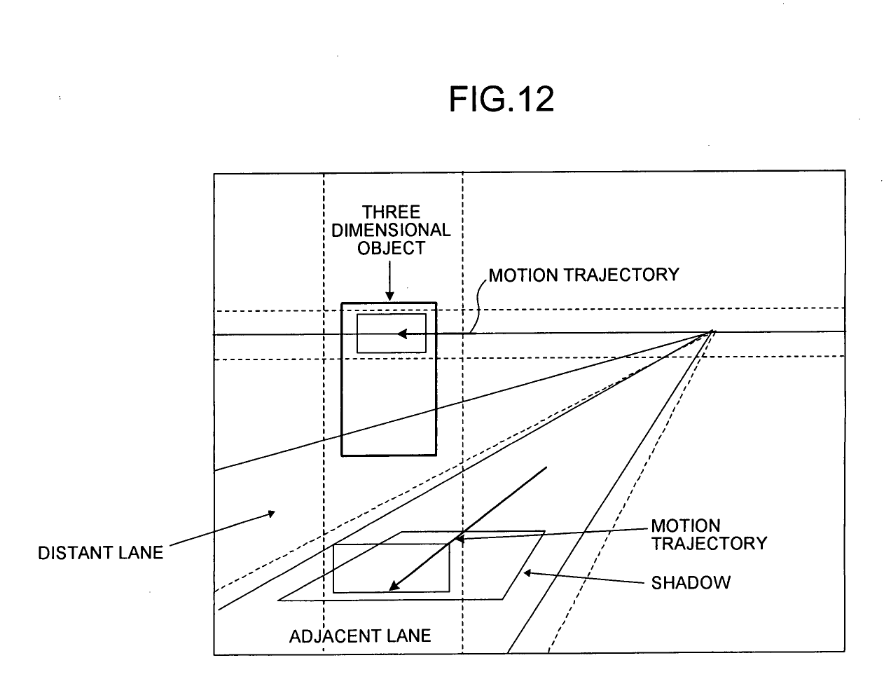

Accordingly, assuming that objects detected in the upper part detection area JS and the lower part detection area KS are the same object as described above, the amounts of movement (horizontal direction) of objects detected in the respective areas must be identical or similar. In other words, if the amounts of movement of objects in the images are not similar, there is a possibility that the respective objects show different objects, respectively, and the respective objects are shadows appearing in the respective areas. For example, as shown in FIG. 12, when the object appearing in the lower part detection area KS and the object appearing in the upper part detection area JS are different such that an automobile travels in a lane next to the adjacent lane and the shadow thereof exists in the adjacent lane, these motion trajectories (shown by heavy arrows in the drawing) have no correlation and are not similar normally.

Accordingly, in the embodiment, after detecting obstacle candidates as described above, whether the amounts of movement of the objects are similar is determined, and if they are similar, they are determined as the same object. If they are the same object, the upper portion (the portion appearing in the upper part detection area JS) of the object and the lower portion (the portion appearing in the lower detection area KS) of the object are aligned along the vertical direction, and thereby, the object can be determined as an obstacle.

In the embodiment, only if a moving object is detected within the lower part detection area KS corresponding to the obstacle detection target area, the obstacle candidate search area SK is set above to perform obstacle detection processing as to whether a moving object exists within the upper part detection area JS or the like. This is based on the following reason. That is, in an area in which the obstacle detecting apparatus 100 should detect an obstacle, an object travels on the road plane in the adjacent line appearing in the lower part detection area KS, and the object must appear in the lower part detection area KS when an automobile or the like is traveling on the adjacent line.

In other words, even if an object is detected in the upper part detection area JS, but no object is detected in the lower part detection area KS, the object detected in the upper part detection area JS can not be an object traveling on the road plane in the adjacent lane as the detection target. Therefore, if only an object is detected in the lower part detection area KS, the above described processing (see step Sa2 shown in FIG. 9 and the subsequent steps) is performed, and thereby, unnecessary processing is not performed so as to reduce the computational cost.

It is conceivable that, if all areas in the image are searched for existence of moving objects and the existence of plural moving objects is detected, and if those objects are aligned along the vertical direction, the objects of interest are defined as obstacle candidates. However, when many automobiles or the like are traveling on the road, many moving objects (portions thereof) exist in all areas in the image shot by the image shooting device 100, and thus, the computational cost increases when all of the objects are detected and obstacle candidates are specified.

On the contrary, in the embodiment, since, by not detecting moving objects in all areas, but by setting plural areas such as the lower part detection area KS and the upper part detection area JS in which moving objects should be detected, moving objects within those areas are detected, the computational cost can be reduced. Further, as in the embodiment, the lower part detection area KS in which the adjacent lane as an area for obstacle detection is set as one processing target area, and the upper part detection area JS including the vanishing line ML is set as the other processing target area. By setting such areas, as described above, an obstacle such as an automobile traveling in the adjacent line can be detected more accurately.

Incidentally, the invention is not limited to the above described embodiment, but various modifications explained as below can be made.

In the above described embodiment, the image shooting device 101 is mounted so that, in the shot image (see FIG. 4), the vanishing line ML of the road in the image may appear along the horizontal direction, however, depending on the way of mounting the image shooting device 101, sometimes an image in which the vanishing line ML in the shot image appears slanted.

When the image shooting device 101 is thus mounted so that an image in which the vanishing line ML is slanted from the horizontal direction may be shot, the image receiving unit 110 may correct the image so that the vanishing line ML in the image may become a line along the horizontal direction, and output corrected image to the processing area setting unit 120. Thereby, it becomes unnecessary to perform processing in consideration of the slant of the vanishing line ML, and the computational cost in the processing area setting unit 120 or the units in the subsequent stages can be reduced.

Further, in the above described embodiment, the areas set by the processing area setting unit 120 are fixed to the upper detection area JS and the lower detection area KS, however, the areas may be made variable.

For example, when an automobile on which the image shooting device 101 is mounted travels around a curve, the area in which the adjacent lane appears in the image shot by the image shooting device 101 differs from the image during traveling on a linear line (see FIG. 4). Therefore, the lower part detection area setting unit 121 may set the lower part detection area KS so that it may include an area in which the adjacent lane varying depending on traveling conditions appears.

In this case, the area in which the adjacent lane appears may be detected by detecting a lane marking on the road for defining the adjacent line from the shot image, or, by providing a yaw rate sensor or the like, the area in which the adjacent lane appears may be estimated based on the detection result thereof, that is, the degree of curve.

Thus, by setting the area so that the adjacent lane may be included in the processing target area even when traveling on the curved road, an obstacle (an object traveling on the adjacent lane) as a detection target can be detected more reliably.

In the above described embodiment, the obstacle determining unit 150 compares the amount of the horizontal component of movement as the motion trajectory in the past given period of the object detected within the lower part detection area KS and the amount of the horizontal component of movement as the motion trajectory in the past given period of the object detected within (the obstacle candidate search area SK of) the upper part detection area JS, and determines that they are an obstacle if they are similar. Although the motion trajectories in the past given period may be thus compared, whether they are an obstacle may be determined by comparing motion trajectories within each of plural intervals.

For example, whether they are similar may be determined by obtaining amounts of horizontal components of movement of both objects in predetermined periods such that amounts of movement of both objects within an interval of time t1 to t2, amounts of horizontal components of movement of both objects within an interval of time t2 to t3, and within an interval of time t3 to t4 (time of detection), and comparing them. Thus, more accurate obstacle detection can be performed for the reason as below. Note that the predetermined periods as intervals for detecting amounts of movement may be set to be equal in all of the intervals, or may be set to be different with respect to each interval.

That is, if the obstacle candidate object detected in the upper part detection area JS and the obstacle candidate object detected in the lower part detection area KS are the same object, when the amounts of movement are compared in the plural intervals as described above, the amounts of movement are similar in any one of the intervals.

On the other hand, when only the amounts of movement in one interval are compared, there is a possibility that, if the amounts of movement of the object appearing in the upper part detection area JS and the object appearing in the lower part detection area KS are similar, or if separate objects move similarly, they satisfy the similarity condition. When they are compared with respect to each of plural intervals, if the movements of the objects at the respective intervals are similar accidentally, they satisfy the similarity condition, however, such a case is thought to be very rare. Therefore, by obtaining and comparing the amounts of movement with respect to each of plural intervals and performing obstacle determination if they are similar as described above, more accurate obstacle determination can be performed.

In the above described embodiment, the processing area setting unit 120 sets two areas such as the upper part detection area JS and the lower part detection area KS, however, three or more areas may be set and the object motion detecting unit 130 may detect motion of objects moving in the respective areas.

Then, as well as in the above described embodiment, if detected that the objects moving in the three or more detection areas are aligned along the vertical direction, they are defined as obstacle candidates. Then, the amounts of movement of the obstacle candidate objects in the respective areas are compared and they may be determined as an obstacle if they satisfy the similarity condition. Thus, by performing obstacle detection processing by setting three or more areas, obstacle determination can be performed more accurately.

In the above described embodiment, the invention has been described by being applied to the apparatus that detects an obstacle such as an automobile existing rearward of an automobile based on images obtained from the image shooting device installed near the side mirror of the automobile of interest, however, the invention can be applied not only to such an apparatus or method for detecting an obstacle traveling rearward of the automobile in the adjacent lane, but to an apparatus or method for detecting other obstacles moving on the plane. For example, it can be applied to an apparatus or method for detecting pedestrians traveling on the road.

As described above, the obstacle detecting apparatus and method according to the embodiments of the present invention are useful for an obstacle detecting apparatus mounted on an automobile or the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An apparatus that detects an obstacle using images shot by an image shooting device mounted on a mobile object on a plane, the apparatus comprising:
an image receiving unit configured to receive time-series images shot by the image shooting device;
an area setting unit configured to set a plurality of processing areas in the images received by the image receiving unit;
an object motion detector configured to detect objects moving within the areas set by the area setting unit and to detect motion trajectories of the objects;
an obstacle candidate detector configured to detect the respective objects as obstacle candidates if a direction of a line connecting between the objects is a predetermined direction; and
an obstacle determining unit configured to compare the motion trajectories of the respective obstacle candidates and to determine the obstacle candidates as an obstacle if the motion trajectories of the obstacle candidates satisfy a predetermined similarity condition.

2. The apparatus according to claim 1, wherein the area setting unit sets a first area in which an obstacle on the plane on which the mobile object moves should be detected, and a second area including a vanishing line of the plane on which the mobile object moves as the processing areas.

3. The apparatus according to claim 2, wherein, if the object motion detector detects an object moving within the first area, the obstacle candidate detector determines whether there is an object within a determination area in a predetermined direction from the detection position of interest in the second area, and detects the objects detected within both areas as obstacle candidates if there is the object moving within the determination area in the second area.

4. The apparatus according to claim 1, wherein the predetermined direction is a vertical direction.

5. The apparatus according to claim 1, wherein the obstacle determining unit compares motion trajectories with respect to each predetermined period of the respective objects detected as the obstacle candidates, and determines the objects as an obstacle if the motion trajectories thereof satisfy the similarity condition.

6. The apparatus according to claim 1, wherein the obstacle candidate determining unit determines the objects as an obstacle if horizontal components of the amounts of movement of the respective objects detected as the obstacle candidates are substantially identical.

7. The apparatus according to claim 1, wherein the image receiving unit performs image correction so as to make the vanishing line of the plane on which the mobile object moves in the image shot by the image shooting device horizontal in the image of interest.

8. The apparatus according to claim 1, wherein the image receiving unit receives an image shot by the image shooting device installed so as to shoot an adjacent lane rearward of an automobile traveling on a road plane near a side mirror of the automobile of interest.

9. A method of detecting an obstacle using images shot by an image shooting device mounted on a mobile object on a plane, the method comprising:
receiving time-series images shot by the image shooting device;
setting a plurality of processing areas in the images received;
detecting objects moving within the plurality of processing areas;
detecting motion trajectories of the objects;
detecting the respective objects as obstacle candidates if a direction of a line connecting between objects is a predetermined direction;
comparing the motion trajectories of the respective obstacle candidates; and determining the obstacle candidates as an obstacle if the motion trajectories of the obstacle candidates satisfy a predetermined similarity condition.

10. The method according to claim 9, wherein the plurality of processing areas includes a first area in which an obstacle on the plane on which the mobile object moves should be detected, and a second area includes a vanishing line of the plane on which the mobile object moves as the processing areas.

11. The method according to claim 10, wherein, if an object moving within the first area is detected, it is determined whether there is an object within a determination area in a predetermined direction from the detection position of interest in the second area, and the objects is detected as obstacle candidates if there is the object moving within the determination area in the second area.

12. The method according to claim 9, wherein the predetermined direction is a vertical direction.

13. The method according to claim 9, wherein the motion trajectories with respect to each predetermined period of the respective objects detected as the obstacle candidates are compared each other, and the objects is determined as an obstacle if the motion trajectories thereof satisfy the similarity condition.

14. The method according to claim 9, wherein the objects are determined as an obstacle if horizontal components of the amounts of movement of the respective objects detected as the obstacle candidates within the respective plurality of processing areas are substantially identical.

15. The method according to claim 9, further comprising, after receiving time-series images, performing image correction so as to make the vanishing line of the plane on which the mobile object moves in the image shot by the image shooting device horizontal in the image of interest.

16. The method according to claim 9, wherein the time-series images received are images shot by the image shooting device installed so as to shoot an adjacent lane rearward of an automobile traveling on a road plane near a side mirror of the automobile of interest.

17. The method according to claim 10, wherein, if an object moving within the first area is detected, the detecting as obstacle candidates determines whether there is an object within a determination area in a predetermined direction from the detection position of interest in the second area, and the detecting as obstacle candidates detects the objects as obstacle candidates if there is the object moving within the determination area in the second area.
